(19) United States
(12) Patent Application Publication
(10) Pub. No.: US 2009/0165607 A1
(43) Pub. Date: Jul. 2, 2009

(54) Universal screw-saver extractor

(76) Inventor: Albert M. Martin, Osteen, FL (US)

Correspondence Address: Albert M. Martin, 155 Bull Run Avenue, Osteen, FL, 32764, US

(21) Appl. No.: 12/005,536

(22) Filed: Dec. 27, 2007

(51) Int. Cl. B25B 23/00; B25B 15/00

(52) U.S. Cl. 81/448; 81/436

(57) ABSTRACT

A device that is utilized exclusively for extraction of plastic inserts such as screws, rivets, nails and the like from plastic housings that are components of automotive panel fasteners; said device being utilized to extract inserts without causing said inserts or housings to be damaged by the extraction process, thereby allowing reuse of said components.

### FEDERALLY SPONSORED RESEARCH

Not Applicable

### SEQUENCE LISTING OR PROGRAM

Not Applicable

### BACKGROUND OF THE INVENTION

1. Field of the Invention

The automotive industry utilizes plastic screws and other such inserts and housings as panel fasteners; said fasteners being required to be removed to facilitate repairs or maintenance, thereby requiring extraction of said inserts which often results in unnecessary and avoidable damage, thus requiring excessive time and expense to accomplish said repair or maintenance.

The current art invention identified in the title above relates to a device that is utilized to extract plastic screws and other such inserts that are already in use without causing damage to the inserts or their housings, thereby allowing their reuse after extraction.

2. Prior Art

Prior art extractors have been utilized primarily for the purpose of extracting broken or damaged threaded metal screws, studs, taps, bolts, pipes, plugs, spikes and other such fasteners from bone, wood, metal and the like by utilizing hand, electric and pneumatic powered devices such as screwdrivers, wrenches, twist drills, drill bits, rods, torx, chucks and various other associative devices, however no prior extractor patents have ever been granted for a device that extracts plastic screws from plastic housings utilized as automotive panel fasteners.

### UNITED STATES PRIOR ART PATENTS

When the USPTO Quick Search databank is accessed by typing into the ‘Term 1’ All Fields' boxes, the query “plastic screw extractor” brings up “Results of Search in Patents Text Collection db for “plastic screw extractors”: 0 patents. No patents have matched your query.”

A further search under other queries brings up the prior art patents listed below; said patents pertaining to extraction devices of one type or another that are utilized to extract various items, damaged or otherwise, from dense materials; however none of those listed claim to extract plastic screws, rivets and nails or the like from plastic housings.

Please note that none of the patents listed below have anything to do with automotive panel fasteners.
1. U.S. Pat. No. 155,429 Devine Sep. 10, 1874 Spike-Extractor
2. U.S. Pat. No. 252,704 Southwick Jan. 24, 1882 Combined Drill And Countersink
3. U.S. Pat. No. 401,113 Baumeister Apr. 9, 1889 Nail Extractor
4. U.S. Pat. No. 1,105,535 Roberts Jul. 28, 1914 Screw Extractor
5. U.S. Pat. No. 1,108,059 Zihler Aug. 18, 1914 Stub Puller;
6. U.S. Pat. No. 1,458,076 Pofts Jan. 5, 1923 Extractor Device;
7. U.S. Pat. No. 1,516,155 Santarelli Nov. 18, 1924 Nail Pulling Device
8. U.S. Pat. No. 1,547,944 Murphree Jul. 28, 1925 Means For Removing Broken Stud Bolts
9. U.S. Pat. No. 1,548,835 French Aug. 11, 1925 Device For Removing Broken Wood Screws;
10. U.S. Pat. No. 1,785,847 Valentine Dec. 23, 1930 Screw Moving Means;
11. U.S. Pat. No. 1,863,045 Randall Jun. 14, 1932 Extractor For Screws And The Like;
12. U.S. Pat. No. 1,863,046 Githers Jun. 12, 1932 Extractor;
13. U.S. Pat. No. 2,281,164 Maling Apr. 28, 1942 Device For Removing Broken Studs;
14. U.S. Pat. No. 2,391,405 Fuglie Dec. 25, 1942 Method Of Removing Broken Studs;
15. U.S. Pat. No. 2,408,450 Schrader Oct. 1, 1946 Broken Stud Remover;
16. U.S. Pat. No. 2,435,137 Geertsema Jan. 27, 1948 Long Shaft Stud Driver
17. U.S. Pat. No. 2,570,914 Buck Oct. 9, 1951 Nail Puller
18. U.S. Pat. No. 2,570,915 Buck Oct. 9, 1951 Nail Puller
19. U.S. Pat. No. 2,694,328 Freniere Nov. 16, 1954 Tools For Removing Studs Or The Like
20. U.S. Pat. No. 2,709,570 Henry May 31, 1955 Pneumatic Nail Puller
21. U.S. Pat. No. 2,735,649 Swallert Feb. 21, 1956 Pneumatic Spike Puller
22. U.S. Pat. No. 2,750,821 Hilsinger Jun. 19, 1956 Tool For Removing Damaged Screws
23. U.S. Pat. No. 2,752,671 Alyea Jul. 3, 1956 Method Of Removing Threaded Shafts;
24. U.S. Pat. No. 2,815,054 Cummaro Dec. 3, 1957 Removal Tool for Recessed Head Screws
25. U.S. Pat. No. 2,897,695 Winslow Aug. 4, 1959 Drill Countersink Bit
26. U.S. Pat. No. 2,863,348 Conger Dec. 9, 1958 Extractor;
27. U.S. Pat. No. 3,106,233 Wolny Oct. 8, 1963 Broken Screw Extractor;
28. U.S. Pat. No. 3,457,812 Wagner July 1969 Tools Having Teeth With Cutting Edges For Gripping And Disassembling Fasteners;
29. U.S. Pat. No. 3,654,690 Hardin Aug. 11, 1972 Method For Removing Broken Studs;
30. U.S. Pat. No. 3,735,650 Weng, Jr May 29, 1973 Extractor Tool
31. U.S. Pat. No. 3,750,500 Peterson Aug. 7, 1973 Dowel Pin Extractor Tool
32. U.S. Pat. No. 3,978,576 Mustoe, Jr. Sep. 7, 1976 Nail Extractor
33. U.S. Pat. No. 3,979,978 Smolik Sep. 14, 1976 Nail Setting Tool
34. U.S. Pat. No. 4,007,913 Aldrich Feb. 15, 1977 Nail Puller
35. U.S. Pat. No. 4,078,766 Saurwein Mar. 14, 1978 Powered Nail Extractor
36. U.S. Pat. No. 4,078,458 Berendzen Mar. 14, 1978 Screw Extractor;
37. U.S. Pat. No. 410,780 Cahn Sep. 29, 1889 Device For Removing Broken Screws
38. U.S. Pat. No. 4,204,308 Marling May 1980 Inner Lug Removal Tool;
39. U.S. Pat. No. 4,350,064 Markle Sep. 21, 1982 Auxiliary Tool Kit For A Socket Wrench Set
40. U.S. Pat. No. 4,389,913 Drouin et al. Jun. 28, 1983 Screw Extractor
41. U.S. Pat. No. 4,434,687 Vickio Mar. 6, 1984 Damaged Screw Extractor
42. U.S. Pat. No. 4,507,837 Hinkle Apr. 2, 1985 Extractor Tool
43. U.S. Pat. No. 4,637,113 Cook Jan. 20, 1987 Tool For Removing And Reapplying Rivets
44. U.S. Pat. No. 4,658,457 Rokita Apr. 21, 1987 Combination Fastener Remover And Dimpler
45. U.S. Pat. No. 4,688,315 Jannke Aug. 25, 1987 Screw Extractor And Method Of Using Same
46. U.S. Pat. No. 4,776,568 Perel Oct. 11, 1988 Nail Puller
47. U.S. Pat. No. 4,815,707 Brown Mar. 28, 1989 Nail Puller
48. U.S. Pat. No. 4,940,370 Gipson July 1990 Screw Extracting Device;
49. U.S. Pat. No. 4,997,163 Henning Mar. 5, 1991 Nail Puller
50. U.S. Pat. No. 5,031,487 Polonsky Jul. 16, 1991 Broken Bolt Extractor
51. U.S. Pat. No. 5,141,205 Iwai et al. Aug. 25, 1992 Nail Remover
52. U.S. Pat. No. 5,213,311 Sabo May 25, 1993 Nail Extractor
53. U.S. Pat. No. 5,251,516 Desaulniers Oct. 12, 1993 Tool For Extracting Broken Bolts & The Like
54. U.S. Pat. No. 5,737,981 Hildeabrand April 1998 Removal Device For Threaded Connecting Devices;
55. U.S. Pat. No. 5,649,791 Connolly Jul. 22, 1997 Apparatus Method For Boring A Hole In A Broken Bolt
56. U.S. Pat. No. 5,737,981 Hildebrand Apr. 14, 1998 Removal Device For Threaded Connecting Devices
57. U.S. Pat. No. 5,984,272 Crider Nov. 16, 1999 Tool For Extracting Headed Nails
58. U.S. Pat. No. 6,015,136 Benudiz Jan. 18, 2000 Portable Fastener Remover Apparatus
59. U.S. Pat. No. 6,105,935 Wagner Aug. 22, 2000 Nail Removal Tool
60. U.S. Pat. No. 6,267,025 Sand Jul. 31, 2001 Broken Pedicle Screw Extractor;
61. U.S. Pat. No. 6,339,976 Jordan Jan. 22, 2002 Tool For Removing Damaged Fasteners And Method For Making Such Tool
62. U.S. Pat. No. 6,761,089 Bergamo Jul. 13, 2004 Tool for removing screws with damaged heads
63. U.S. Pat. No. 6,729,208 Chrzanowski May 4, 2004 Tool for removing fasteners;
64. U.S. Pat. No. 6,755,392 Phillips Jun. 29, 2004 Nail Extractor;
65. U.S. Pat. No. 6,877,401 Giltner Apr. 12, 2005 Apparatus For Extracting Fasteners From A Host Material;
66. U.S. Pat. No. 6,997,086 Graham Feb. 14, 2006 Locking Screwdriver;
67. U.S. Pat. No. 7,090,680 Bonati Aug. 15, 2006 Method For Removing Orthopaedic Hardware;
68. U.S. Pat. No. 7,140,087 Giltner Nov. 28, 2006 Methods For Extracting Fasteners From A Host Material.
69. U.S. Pat. No. 7,171,871 Kozak Feb. 6, 2007 Damaged bolt and screw removing devices; and
70. U.S. Pat. No. 7,240,588 Rinner Jul. 10, 2007 Method Of Making A Tool For Extracting A Broken Screw.

### COMPARATIVE ANALYSIS

Typically, the devices identified in the prior art patents listed above pertain to the extraction of broken or damaged metal parts that are embedded directly into dense materials such as poured concrete, metal, wood, bone and the like; said parts needing to be replaced with new parts; whereas, the device identified in the current art pertains exclusively to parts made of plastic; said plastic parts not being damaged before or during extraction, thereby allowing the extracted parts to be reused.

### UN-OBVIOUSNESS

The first patent listed above (U.S. Pat. No. 155,429) was granted Sep. 10, 1874 (133 years ago) and since that time more than 7,153,290 patents have been granted by the USPTO and no one has heretofore found the current art applied for by this application to be obvious; the applicant being the sole exception; thereby affirming the applicant's contention that the patent sought herein is patentable.

### OBJECT

The object of the invention is to provide a contemporary extraction device for extracting plastic screw nails, screw rivets, screw retainers and the like from plastic housings utilized in the automotive industry without causing damage to either plastic component; said extraction device being comprised of one or more metal pieces and further comprised of none, one or more than one surfacing material(s).

### ADVANTAGES

The invention identified, described, specified, delineated and shown herein is physically an exceptionally strong device; the primary embodiment being manufactured in one piece of high strength steel such as, but not limited to, stainless steel or tool steel, thereby assuring long life and reducing costs of tool replacement.

Also, the device may be used with or without other tools and operation of the device requires no set up, thereby assuring speed of operations, thus reducing labor costs.

Additionally, the device is very small, simplistic in design, user friendly and inexpensive when compared to the extraction devices of prior art patents listed above.

Further, when high-speed power tools are employed, the operation is completed in two movements lasting less than a few seconds.

Furthermore, the extracted part and the housing may be re-used, thereby eliminating replacement costs.

### BRIEF DESCRIPTIONS OF THE DRAWINGS

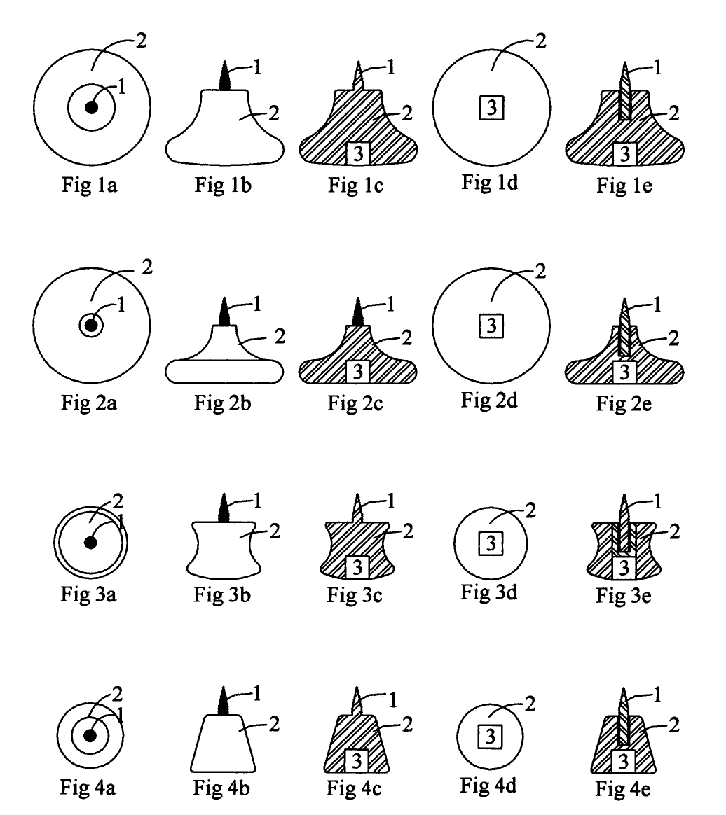

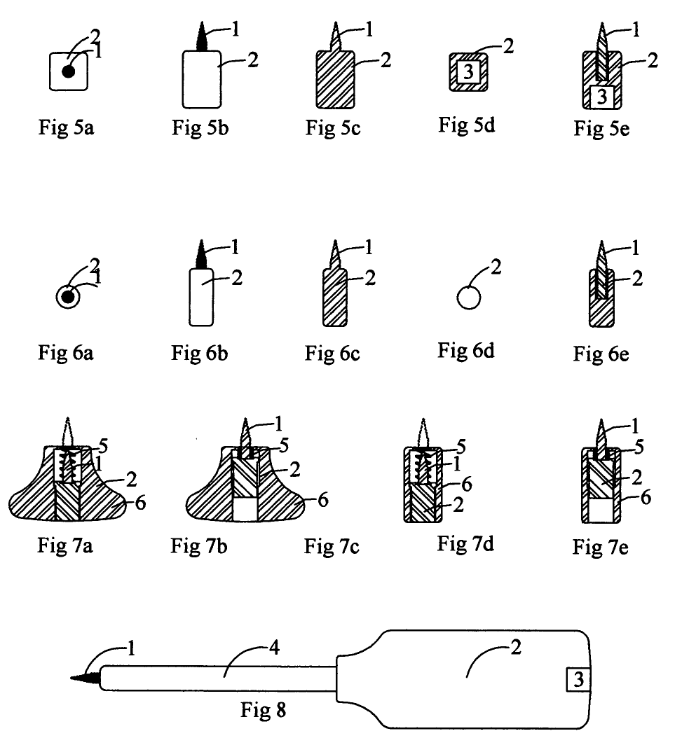

### Seven Models—Un-Limited Possibilities

| | |
|---|---|
| FIG. 1a: Screw Side | 1 = Protruding Screw |
| FIG. 1b: Elevation | 2 = Body |
| FIG. 1c: Section, one-piece Model | 3 = Tool Entry Recess |
| FIG. 1d: Tool entry side | 4 = Rod |
| FIG. 1e: Section, two-piece model | 5 = Spring |
| FIG. 2a: Screw Side | 6 = Housing |
| FIG. 2b: Elevation | |
| FIG. 2c: Section, one-piece model | |
| FIG. 2d: Tool entry side | |
| FIG. 2e: Section, two-piece model | |
| FIG. 3a: Screw Side | |
| FIG. 3b: Elevation | |
| FIG. 3c: Section, one-piece model | |
| FIG. 3d: Tool entry side | |
| FIG. 3e: Section, three-piece model | |
| FIG. 4a: Screw Side | |
| FIG. 4b: Elevation | |
| FIG. 4c: Section, one-piece model | |
| FIG. 4d: Tool entry side | |
| FIG. 4e: Section, two-piece model | |
| FIG. 5a: Screw Side | |
| FIG. 5b: Elevation | |
| FIG. 5c: Section, one-piece model | |
| FIG. 5d: Tool entry side | |
| FIG. 5e: Section, two-piece model | |
| FIG. 6a: Screw Side | |
| FIG. 6b: Elevation | |
| FIG. 6c: Section, one-piece model | |
| FIG. 6d: Tool entry side | |
| FIG. 6e: Section, two-piece model | |
| FIG. 7: Typical spring-operation model | |
| FIG. 8: Any Side | |

### DETAILED DESCRIPTION

### Utility

Anyone knowledgeable in the field of bodyshop and mechanical repair knows how difficult it is to extract plastic inserts from plastic housings utilized as panel fasteners in automobiles and other vehicles due to the fact that said inserts are installed by pushing them in place (not screwing them in place) and extracting them by pulling them out, (not unscrewing them out); consequently, the fasteners are often damaged during extraction due to the fact that no tool that will solve the problem has ever been invented and patented to date. The current art device identified herein, however, does solve said problem, therefore demonstrating its usefulness.

### DETAILED DESCRIPTION

### Operation

The device may be employed by hand whereby the protruding screw-like portion is screwed to the hilt into the plastic insert and immediately pulled to extract said insert; a process that takes 5 to 10 seconds or if an electric or pneumatic tool is employed the process takes two to three seconds.

### DETAILED DESCRIPTION

### Novelty

The patent sought herein pertains to a device that is novel in a number of ways: 1) it is utilized exclusively for extraction of plastic screws, rivets, nails and the like that are associated with automotive panel fasteners; 2) it is also utilized for the purpose of extracting only un-damaged inserts such as plastic screws, rivets, nails and the like; 3) it does not cause the insert or the housing to be damaged, before or during or extraction; 4) it may be utilized with or without other tools; and 5) it utilizes a metal screw-device to extract a plastic screw as well as other inserts; said screw-device and screw being threaded in the same direction.

### DETAILED DESCRIPTION

### Physical Structure

The primary embodiment is comprised of one piece of metal with a conically threaded shank having spiral cutting threads along its exterior resembling the shape of a screw; said shank protruding from one side of said piece and a square, circular, hexangular or the like shaped recessed area that accommodates tools on the opposite side of the piece.

### DETAILED DESCRIPTION

### Manufacture and Production

Any credible metal shop or machine shop with at least one competent laborer skilled in the art of metal work can manufacture the current art device to which this patent application pertains and there are tens of thousands, if not hundreds of thousands of such businesses all over the world that are available to produce the device.

### DETAILED DESCRIPTION

### Preferred Embodiment

The preferred embodiment is a four-piece device made of Stainless Steel, Tool Steel or other high-strength steel; said four-piece device having a spring operated mechanism that deploys the extraction screw automatically when a tool is engaged to aid in the extraction process and retracts the extraction screw when the tool is disengaged.

### DETAILED DESCRIPTION

### Additional Embodiments not being Spring Operated

One added embodiment is a one-piece device made of Stainless Steel, Tool Steel or other high-strength steel; said other high-strength steel being finished with a coated exterior surface material.

Another embodiment is a two-piece device made of tool steel or other high-strength steel finished with a coated exterior surface material.

Another embodiment is a three-piece device made of high-strength steel with a galvanized finish.

### DETAILED DESCRIPTION

### Conclusion

The applicant is an accomplished bodyshop practitioner; having been skilled in the art of automobile bodyshop work since 1959 and being the current owner of his own body shop as well as several other body shops over the years, therefore being an authority in the art.

1. (canceled)

2. (canceled)

3. A screw-saver extractor device comprising a conical-shaped shank resembling the shape of a screw; said shank having thin and sharp integral spiral cutting threads along an end-portion of its length.

4. The screw-saver extractor device according to claim 3 being integral in one piece.)

5. The screw-saver extractor device according to claim 3 being integral in one piece and having a tool-driver access in the opposite end of said device.)

6. The screw-saver extractor device according to claim 3 being combined with one or more pieces.

7. The screw-saver extractor device according to claim 3 being combined with one or more pieces and having a tool-driver access in the opposite end of the device.)

8. The screw-saver extractor device according to claim 3 being combined with two or more pieces, one being a moveable piece and one being a spring.

9. The screw-saver extractor device according to claim 3 combined with two or more pieces, one being a moveable piece, one being a spring and one having a tool-access in the opposite end of the device.
